(19) United States
(12) Patent Application Publication
(10) Pub. No.: US 2022/0099831 A1
(43) Pub. Date: Mar. 31, 2022

(54) SENSOR ARRANGEMENT ON AN AUTONOMOUS PERSONAL MOBILITY VEHICLE

(71) Applicant: Rajeev Ramanath, SAN JOSE, CA (US)

(72) Inventors: Rajeev Ramanath, SAN JOSE, CA (US); Julio Cesar Castañeda, Winter Park, FL (US)

(73) Assignee: Rajeev Ramanath, SAN JOSE, CA (US)

(21) Appl. No.: 17/484,400

(22) Filed: Sep. 24, 2021

Related U.S. Application Data
(60) Provisional application No. 63/083,133, filed on Sep. 25, 2020.

(51) Int. Cl. G01S 15/931; G05D 1/02; A61G 5/04; A61G 5/10

(52) U.S. Cl. CPC G01S 15/931; G05D 1/0246; G05D 2201/0206; A61G 5/10; G01S 2015/937; A61G 5/04

(57) ABSTRACT

The invention envisages a sensor system to be placed onto a personal mobility vehicle. The vehicle includes a structured light sensor that senses one or more obstacles and generates a first sensor data, and a first mechanical coupling that couples the structured light sensor to either a base frame onto which the wheels of the vehicle are attached or the skirt of the vehicle. The system also includes a processing unit that receives and processes the first sensor data and determines a depth of one or more obstacles, and further generates a location information of one or more obstacles.

### FIELD OF INVENTION

The present invention relates to a personal mobility vehicle. Specifically, the invention relates to the autonomous functioning of a personal mobility vehicle based on sensor inputs. More specifically, the invention relates to the arrangement of sensors on the personal mobility vehicle for the optimal autonomous function of the personal mobility vehicle.

### BACKGROUND OF INVENTION

Personal mobility vehicles are generally driven by people with restricted or limited mobility of those with disabilities. However, to drive them sometimes requires a set of skills that takes time to master. It can be challenging for a novice user and there is a high probability that due to a lack of skill to drive the vehicle, the vehicle might collide with an obstacle. Even after appropriate time with the vehicle, the vehicle may be required to be driven in a challenging environment, either due to the layout of the airport or the congestion involved. The environment may have multiple moving obstacles, obstacles that are narrowly spaced with respect to each other, etc. These environments pose challenges to even skilled drivers, as the driver may have a perception for the obstacle which may not be appropriate, and which may result in the driver colliding with the obstacle.

To solve such issues of manual driving of the personal mobility vehicles, some safety mechanisms may be in place which gives lesser reliance on manual inputs and have protective measures through automated means. These personal mobility vehicles rely on certain sensor inputs to make the decision for providing protective measures. However, there is a strong reliance on the quality of sensor inputs received with respect to obstacles in the way of the vehicles. Such vehicles somehow fail to provide optimal safety measures because of a lack of proper area coverage by these sensors, and hence the inputs received by the automatic system of such machines have incomplete information to make decisions. Sometimes, along with lack of coverage, the inputs provided are unreliable and may have a lot of false positives, or true negatives, which further makes the functioning of the automatic system of these vehicles more unreliable.

Hence, a mechanism is desired where automatic systems of these personal mobility vehicles shall be fed with data from a properly covered traversing area, and such data fed should be more reliable.

### OBJECTIVE OF INVENTION

The objective of the invention is to provide a mechanism for providing reliable sensor inputs for the maximum possible traversing area of the personal mobility vehicle.

### SUMMARY OF INVENTION

The objective of the invention is achieved by a sensor system to be placed onto a personal mobility vehicle. The vehicle includes a structured light sensor that senses one or more obstacles and generates a first sensor data, and a first mechanical coupling that couples the structured light sensor to either a base frame onto which the wheels of the vehicle are attached or a skirt of the vehicle. The system also includes a processing unit that receives and processes the first sensor data and determines the depth of one or more obstacles, and further generates a location information of one or more obstacles.

According to one embodiment of the sensor system, wherein the structured light sensor senses the obstacles placed in a distance range of 50 centimeters to 800 centimeters. This embodiment is helpful, as it allows for depth measurement for obstacles that are placed in long range.

According to another embodiment of the sensor system, the system includes a vision sensor that senses one or more obstacles and generates a second sensor data, and a second mechanical coupling adapted to couple the vision sensor to either an armrest of the vehicle or a torso of the vehicle. The processing unit receives and processes the first sensor data and the second sensor data and generates the location information of one or more obstacles. This embodiment is helpful as it helps in the fusion of depth data, and image data of the obstacles which are placed at a long range, and provide for the optimal determination of the location information of the obstacles.

According to yet another embodiment of the sensor system, wherein the vision sensor senses the obstacles placed in a distance range of 50 centimeters to 800 centimeters. This embodiment is helpful, as it provides images of obstacles that are placed in long range.

According to one embodiment of the sensor system, the system includes an ultrasonic sensor that senses one or more obstacles and generates a third sensor data. The system also includes a third mechanical coupling which couples the ultrasonic sensor to either a base frame onto which the wheels of the vehicle are attached or a skirt of the vehicle. The processing unit receives and processes the first sensor data and the third sensor data and generates the location information of one or more obstacles. This helps to provide optimal coverage of sensors that are placed in short-range, as well as long-range. Also, the placement of ultrasonic sensors at lower heights helps in reducing bling spots near the vehicle.

According to another embodiment of the sensor system, wherein the ultrasonic sensor senses the obstacles placed in a distance range of 0 centimeters to 300 centimeters. This embodiment is helpful, as it provides location information of obstacles that are placed in short-range, including some obstacles that are close to the vehicle.

According to yet another embodiment of the sensor system, the system includes more than one ultrasonic sensor, and the processing unit activates the ultrasonic sensors based on a predefined logic where at least one of the ultrasonic sensors is activated at a different time frame with respect to activation of other ultrasonic sensors. This embodiment is helpful, as it fires only a few ultrasonic sensors at a time, and thus helps to run the sensor system with lower computational power also.

According to one embodiment of the sensor system, wherein the predefined logic defines for activation of the ultrasonic sensors which has a field of view in a direction of movement of the vehicle, and accordingly, the processing unit activates the ultrasonic sensors that have the field of view in the direction of the vehicle. This embodiment is helpful, as it only activates ultrasonic sensors which are relevant during a particular movement of the vehicle, and hence, saves computational power used for running the sensor system

According to another embodiment of the sensor system, the system includes one or more elevated sensors which include one or more depth sensors, or one or more image sensors, or both. The elevated sensor senses a fourth sensor data comprising either a depth information of the obstacles, or a location information of the obstacles, or both. The system also includes a fourth mechanical coupling which couples the elevated sensors to an elevated structure of the vehicle above the height of the head of a user of the vehicle when the user is seated on the vehicle. The processing unit receives and processes the first sensor data and the fourth sensor data and generates the location information of one or more obstacles. This embodiment is helpful, as additional vision-based sensors which are placed at such height provide a wider and unobstructed view of the environment, and can be helpful in the identification of obstacles placed far away, and thus helps in better navigation planning.

According to yet another embodiment of the sensor system, wherein the elevated sensors are mechanically coupled to the elevated structure, such that the elevated sensors are vertically tilted downwards. Tilting of the elevated sensors helps in reducing blind spots close to the vehicle,

### BRIEF DESCRIPTION OF DRAWINGS

FIG. 1 illustrates a plan view having a wheelchair with various short-range sensors placed on the wheelchair, with coverage of each of the sensors.

FIG. 2 illustrates the placement of short-range sensors at different locations and angles on a wheelchair along with their coverage.

FIG. 3 illustrates one camera sensor placed onto a wheelchair with different Field of Views (FOVs).

FIG. 4 illustrates four cameras with 165° FOV onto the wheelchair, so as to get a 360° coverage.

FIG. 5 illustrates the placement of one 360° onto a wheelchair for uniform coverage of a plan view.

FIG. 6 illustrates placements of the camera with vertical FOVs onto a wheelchair.

FIG. 7 illustrates a plan view coverage when 6 cameras of FOVs between 60° and 90° are placed on the skirt of a wheelchair.

FIG. 8 illustrates FOV coverage of cameras when they are installed on a flagpole of a wheelchair with vertical FOV.

FIG. 9 illustrates an embodiment with the placement of long-range sensors and short-range sensors on the torso of a wheelchair.

FIG. 10 illustrates an embodiment where long-range sensors are placed on the torso of a wheelchair, and short-range sensors are placed on the skirts of the wheelchair.

FIG. 11 illustrates an embodiment where both long-range sensors, and short-range sensors are placed on the skirt of the wheelchair.

FIG. 12 illustrates an embodiment where long-range sensors are placed on the flagpole of a wheelchair, and the short-range sensors are placed on the torso of the wheelchair.

FIG. 13 illustrates an embodiment, where long-range sensors are placed on a flagpole of a wheelchair, and short-range sensors shall be placed on the skirt of the wheelchair.

FIG. 14 illustrates an embodiment, where long-range vision sensors are on the flagpole of the wheelchair and short-range sensors are on the skirt of the wheelchair.

FIG. 15 illustrates a representative diagram of an exemplary personal mobility vehicle having four types of sensors placed onto the vehicle.

FIG. 16 illustrates the field of view of the sensors of the personal mobility vehicle of FIG. 15

FIG. 17 illustrates a schematic diagram of a sensor system placed onto the personal mobility of FIG. 15.

The figures depict embodiments of the disclosure for purposes of illustration only. One skilled in the art will readily recognize from the following description that alternative embodiments illustrated herein may be employed without departing from the principles of the disclosure described herein.

### DETAILED DESCRIPTION

The best and other modes for carrying out the present invention are presented in terms of the embodiments, herein depicted in the drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced items.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

Please note throughout the disclosure, “powered wheelchair”, “wheelchair”. “personal mobility vehicle” are interchangeably used. All the embodiments mentioned in the current disclosure are applicable on personal mobility vehicles, as well as wheelchairs.

The invention envisages various arrangements of various sensors which feed data to the automatic system of a personal mobility vehicle or wheelchair. The sensors used are long-range sensors and short-range sensors, with optimal numbers of each of them, and with optimal placement of each of them, so that a proper coverage of the traversing area of the personal mobility vehicles is carried out, and the data captured is reliable for the automatic system to determine obstacles, and further based on the determination of obstacles, planning of traversing a path of the personal mobility vehicle.

This invention further elaborates various possible arrangements of long-range sensors and short-range sensors in a wheelchair in order to obtain complete and reliable coverage of the scene. The arrangements are also applicable for any Personal Mobility Devices (PMD).

In order to determine the space available for the movement of a wheelchair, the space around an autonomous or semi-autonomous wheelchair needs to be monitored for obstacles, stationary or moving. In order to achieve this, the types of sensors used and their placement is critical.

The space of solutions can be divided into those sensors that have a long range and those sensors that have a short range.

The goal of the long-range sensors is to capture scene information about obstacles that are at relatively long distances, typically greater than 50 cms and up to about 800 cms, with high spatial resolution. These long-range sensors provide a high-fidelity version of the scene. Exemplar sensors in this solution space include a 1D or 2D LIDAR sensor, a stereo-vision-based sensor, a depth sensor using structured light, or simply a monocular vision sensor with a wide field of view.

The goal of the short-range sensors is to capture scene information about obstacles that are shorter distances away, typically from ˜0 cm to about 300 cms with low spatial resolution. These short-range sensors provide a lower fidelity view of the scene but are able to capture details of obstacles and objects are much closer proximity. Exemplary sensors in this solution space include infrared proximity sensors, infrared distance sensors, ultrasonic sensors, LIDAR range sensors, Time of Fight sensors, etc.

The goal of spatial coverage using both long- and short-range sensors is to ensure that the obstacles that are farther away from the vehicle are available in higher resolution to enable wayfinding and path planning and the same time ensure that the vehicle does not collide with obstacles that are close to the vehicle. It is this combination of sensors with varying spatial coverage that is of critical importance for the wheelchair or PMD.

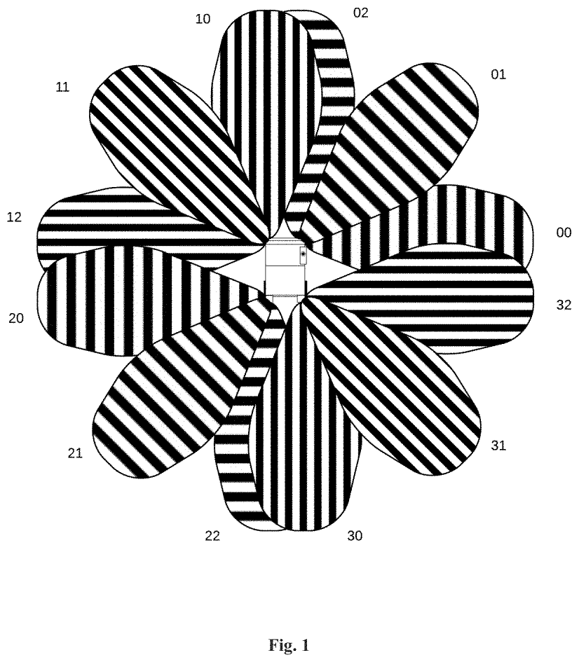

In furtherance, various possible placements of the sensors and their field of view are discussed from FIG. 1-14.

In the plan view as shown in FIG. 1, the object in the middle is representative of the wheelchair 101. A total of twelve short-range sensors whose field of view are denoted as 00, 01, 02, 10, 11, 12, 20, 21, 22, 30, 31, 32, some of which are overlapping. These sensors are placed around the perimeter of the vehicle 101. The count of the number of short-range sensors is a function of the short-range field of view of the short-range sensors themselves. Specifically, in this example, the sensors (ultrasonic, time of flight, radar, or proximity sensors) have a horizontal field of view of roughly 30 degrees each. This allows for uniform coverage of the areas around the object. If the field of view is larger, while one could contend that the number of sensors could reduce, one also has to address the fact that these sensors have limited spatial resolution and hence will not be able to distinguish the precise location of an obstacle. The trade-off of the number of sensors versus the field of view is highly dependent on the resolution of these sensors.

Given that these sensors, ultrasonic, TOF or proximity sensors, are based on the emission of a signal and measuring the time needed for the return, in such an arrangement, it is useful to have the various short-range sensors fire their transmit signals at different times so as to not cause false estimates of obstacles. The following specific means for firing the short-range sensors can be implemented:
1. The firing of a single short-range sensor at a time to minimize any echo and potential signal conflicts.
   a. Sequentially or randomly fire transmit (Tx) signal on sensors having a field of view from 00 through 32 after the receive (Rx) signal on each sensor is returned with a specific timeout (so as not to wait infinitely).
   b. This is by far the slowest way to scan a scene as the complete map would be built up only after all signals have had a Tx Rx pair occur. For example, in the case of an ultrasonic signal, if the max distance we want to map around the vehicle is 2 m, each sensor would take at most 2 m÷343 m/s (speed of sound in normal ambient conditions in air)=5.8 ms allowing for completion in 12*5.8=69.6 ms which is an approximate max refresh rate of 14 frames a second.
2. The firing of two short-range sensors simultaneously to minimize potential conflicts.
   a. Simultaneously fire the following pairs of short-range sensors in succession (or any random order)
      i. Sensors having a field of view of 00 and 20
      ii. Sensors having a field of view of 01 and 21
      iii. Sensors having a field of view of 02 and 22
      iv. Sensors having a field of view of 10 and 30
      v. Sensors having a field of view of 11 and 31
      vi. Sensors having a field of view of 12 and 32
   b. This is the next fastest way to scan a scene. For example, in the case of an ultrasonic signal, if the max distance we want to map around the vehicle is 2 m, each sensor pair would take at most 2 m÷343 m/s=5.8 ms allowing for completion in 6*5.8=34.8 ms which is an approximate max refresh rate of 28 frames a second. This allows the solution to be in the realm of usability from an application standpoint.
3. While the firing of three short-range sensors simultaneous is possible, given the fact that there are twelve short-range sensors in this example, the preference shall be to fire four short-range sensors simultaneously
   a. Simultaneously fire four short-range sensors in succession (or any random order)
      i. Sensors having a field of view of 00, 10, 20 and 30
      ii. Sensors having a field of view of 01, 11, 21, and 31
      iii. Sensors having a field of view of 02, 12, 22, and 32
   b. This is by far the fastest and yet least likely to cause interference between signals. Continuing on the above example, of 2 m distances, the refresh can be as fast as 4*5.8=23.3 ms which is a refresh rate of 43 frames a second which is well in the realm of usability
4. Fire short-range sensors that are orthogonal to each other, such as 00, and 02
5. Depending upon the direction of movement, fire only the short-range sensors that are in the path of movement. In other words, if the movement is in the forward direction, only fire sensors having the field of view of 00 through 12 and if the direction of movement is in the backward direction, only fire sensors having field of view of 20 through 32. This allows for a faster refresh rate as all sensors with non-overlapping fields of view can be fired simultaneously. For example, when the direction of movement is in the forward direction,
   a. Fire three short-range sensors simultaneously
      i. Sensors having a field of view of 00, 02, 12, followed by
      ii. Sensors having a field of view of 01, 10 and 12
      iii. This results in a refresh time period of 2*5.8=11.6 ms or a refresh rate of 86 frames per second which is the most desirable from a usability standpoint

A similar example can be described for backward movement. Again, which and how many short-range sensors to fire simultaneously is entirely dependent on the field of view of the short-range sensors and the numbers of short-range sensors used.

In the case of a time of flight or IR-based proximity sensor, the time periods get to be significantly faster given the fact that the speed of light is 3*10\hat{ }10 m/s; but the fields of view might be smaller which will potentially result in more sensors being used. In the case of radar sensors, while the range detected by a radar sensor is inversely proportional to the frequency of the signal used, the biggest challenge of using radar sensors is their power budgets. With the conventional automotive radars operating at a range of 24-80 GHz, the ranges observed span hundreds of meters to 0.5 m. Even at the shortest ranges, of 0.5 m (and 80 GHz), obstacles distances at a range of 0.5 m can be detected in a similar arrangement of sensors.

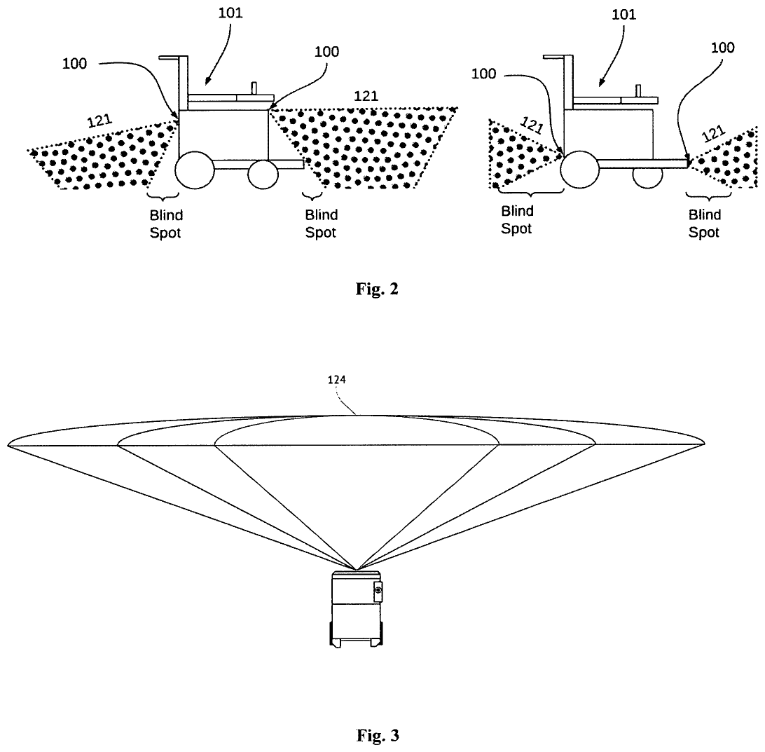

FIG. 2 shows a side view of the short-range sensor 100 placement with their short-range field of views 121. The intent is to minimize the blind spots in front of the vehicle 101 to ensure that the vehicle 101 is always aware of the obstacles around it. In other words, the vertical position and angle of the short-range sensors 100 should be such that the blind spot areas are minimized.

While it is possible to make the blind spot close to zero, it is essential to also understand the ergonomics of the wheelchair, i.e., the location of placement of arms, legs, and clothing of the users. Also, it is significant to account for the manner of interaction of the wheelchair with the world, manufacturing tolerances, movement of the components of the wheelchair during and after repeated use. These all factors shall impact the accuracy desired.

The placement of long-range sensors is a function of the available computing power onboard on the vehicle. For example, while one can envision the use of multiple vision-based solutions, or multiple radar sensors, flash LIDAR systems, multiple 1D LIDARs, to get complete coverage, the more cost-effective solutions involve the use of cameras or alternatively 2D flash LIDARs. The placement of these sensors is described in this invention.

For illustration purposes, one camera sensor is shown in FIG. 3 with a choice of possible FOVs 124. While these commercially range from 60° to 180° horizontal and vertically, with different levels of lens distortions, high volume commercially available cameras have a FOV 124 between 120° and 165°. The associated coverage is shown in FIG. 3 with three different fields of view shown.

The choice of the FOV is going to be a function of the amount of computing power available on the on-vehicle systems. The larger the FOV, the larger the sensor (and possibly resolution) needs to be, which in turn increases the demand for transmission and computation capabilities. Further, the choice of single or multiple cameras also plays a role as each view requires its own computational complexity.

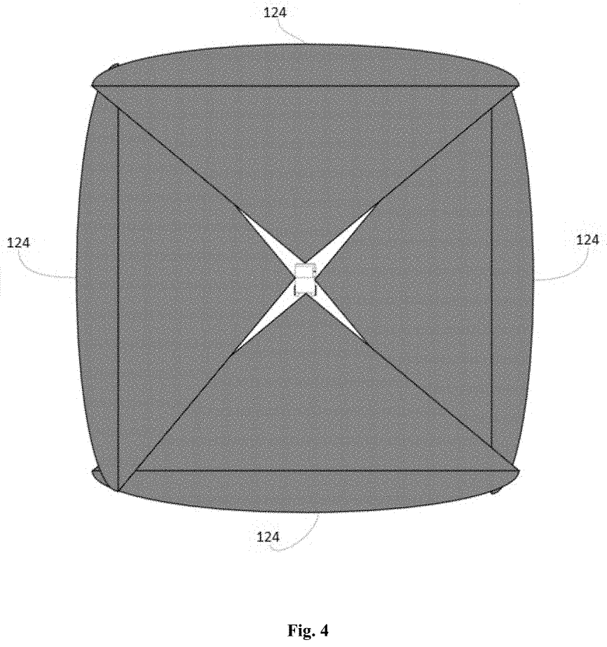

In another embodiment, FIG. 4 illustrates the potential placement of four camera sensors to get 360° coverage, which is accomplished with four camera sensors having 165° FOV 124. While this is showing a plan view of the wheelchair, the challenge with such an approach is the fact that the wheelchair is now increasingly becoming more like a car with a chassis that requires a robust frame that can manage the presence of cameras. Further, using monocular cameras requires the estimation (as opposed to the computation or measurement) of depth. The four camera sensors can be fired simultaneously and processed on an on-vehicle computer with CPU and GPU accelerators combined with neural network accelerator cores to provide the necessary obstacle avoidance solutions.

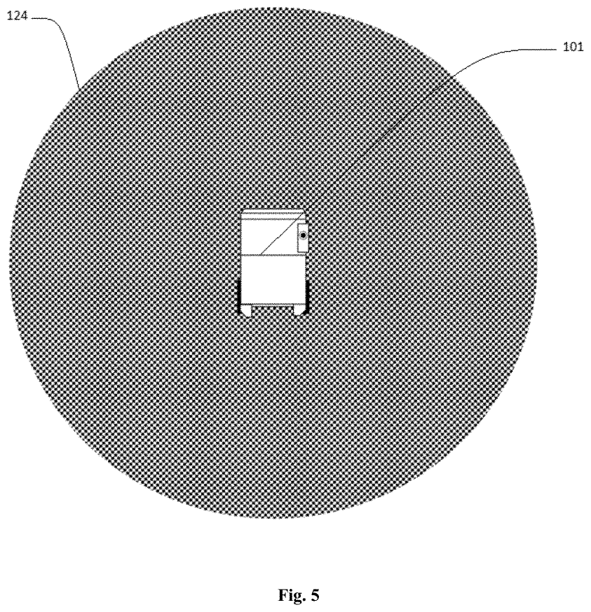

In another embodiment, as shown in FIG. 5, data from a 360° camera sensor placed onto the vehicle 101, can also be used to get uniform coverage in the plan view through a 360° Field of view 124.

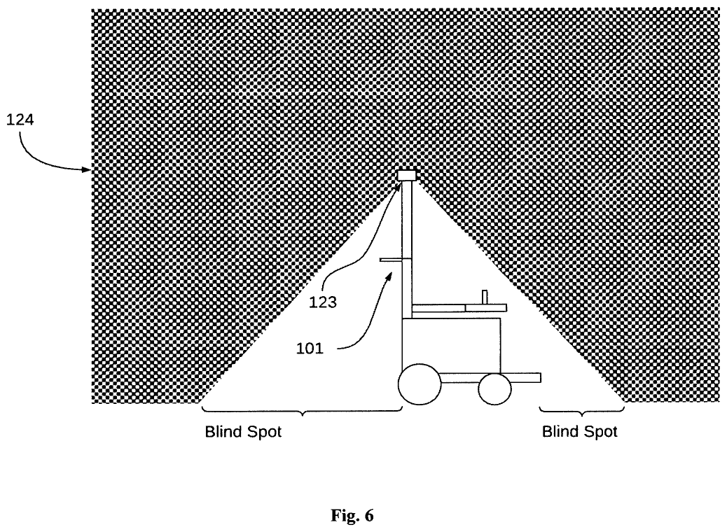

These solutions are compact and relatively straightforward to implement and come with minor disadvantages of vertical FOV 124 as shown in FIG. 6, which shows the camera sensor 123 is placed onto a flagpole of the vehicle 101. However, such elevated sensors can be complemented by short-range sensors to overcome the blind spot disadvantages.

For implementations that require a precise calculation of depth for obstacle avoidance, depth cameras are used. These come in at least two types, i.e., depth cameras which use structured light patterns, and stereo cameras that use disparity maps to determine distance.

Depth cameras that use structured light patterns work by projecting structured light patterns (generally in near-infrared light) onto a scene and capturing them with a camera to compute the disparity in the scene. This is a common approach taken by these kinds of cameras to determine distances to objects. However, there are certain shortcomings of these cameras, such as:
If the ambient light is flooded by infrared light the camera is unable to discern the projected dots. A way around this problem is to increase the power of the illuminator being used to create the dots.
If objects have poor reflectivity, the dot patterns are not visible
If objects are too close to the camera-projector pair, the dots are not seen by the camera.
If the projector or the camera is occluded, the dots are not visible, and hence any computation is not possible

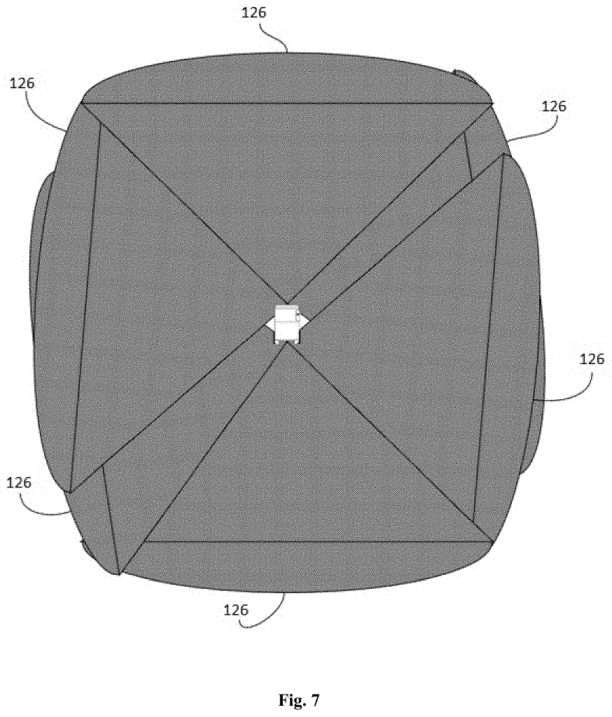

These depth cameras typically have a depth camera FOV 126 between 60° and 90°. If installed along the skirt of the vehicle, in order to get full coverage of the scene, at least six depth cameras must be used, as shown in FIG. 7, to ensure both overlapping coverage of the scene and complete coverage, each facing different directions. The vertical tilt and position of the camera must be such that the ground immediately around the vehicle is clearly visible in order to determine obstacles that are immediately in front of the direction of motion.

FIG. 8 shows the installation of depth cameras 125 on a flagpole or vertical structure of the vehicle 101. These depth cameras can be reduced to either four cameras with a line-to-line overlap of the field of view or use a 360° degree camera. The vertical tilt in this scenario must ensure that the surface immediately around the vehicle is visible in order to determine obstacles that are immediately in front of the direction of motion. While there are advantages of using this approach:
The dead zone immediately in front of the cameras (which is normal in the case of a structured light camera) is of no immediate importance so long as the dead zone is less than the height of the cameras
The sensors are in a safe location so as to not get impacted by inadvertent collisions

However, this comes with a significant shortcoming in that the passenger on the wheelchair and the wheelchair itself have a high likelihood of blocking the dot patterns or the returning signals and hence creating a larger blind spot for the system, as shown in FIG. 8.

An abstraction of structured light camera systems is a 2D flash LIDAR that has similar performance characteristics except that given that it is a high-power laser, it is able to project the dots to a much farther distance. In the application of a wheelchair, while feasible is not practical as it provides us capabilities that we do not have a need for: long ranges, high power, high computational complexity.

Stereo camera solutions for depth estimation come with increased challenges with the computational complexity of having to process disparity maps between stereo pairs, requiring them to be assembled in a robust manner relative to each other, and most importantly, needing to have some level of self-calibration in the field. These solutions generally work well when the physical assembly of the camera modules is not impacted by the movement of the vehicle (automotive grade assemblies) or when the cameras themselves are stationary.

While the advantages, challenges, and design constraints to a stereo pair solution are generally similar to structured light solutions, one added advantage to stereo pair solutions is the fact that it works under high ambient lighting conditions (where structured light solutions are challenged).

Given the challenges of blind spots that occur with long-range sensors and the challenges of limited range with the short-range sensors, the combination of the two types of sensors is of particular interest where the long-range sensors allow for data that can be used for path planning and the short-range sensors can be used for collision avoidance. The placement of these two types of sensors, away from the rider's arms, legs, and clothing, combined with the use cases (possible obstacles to identify and avoid) that need to be addressed give rise to a few embodiments.

The key use cases that are being addressed are:
Static obstacles like walls, furniture, and other fixed assets
Dynamic obstacles like moving people, vehicles, or objects
Distances to obstacles being in the range of 0-5 m
Path planning
Collision avoidance
Response times from sensors being less than 15 ms

In all these examples, the choice of the number of long-range sensors is a function of the computation and cost budgets of the product. Given that the short-range sensors are relatively low cost and have low computational complexity, the choice of the number and type of short-range sensors is a function of the coverage desired.

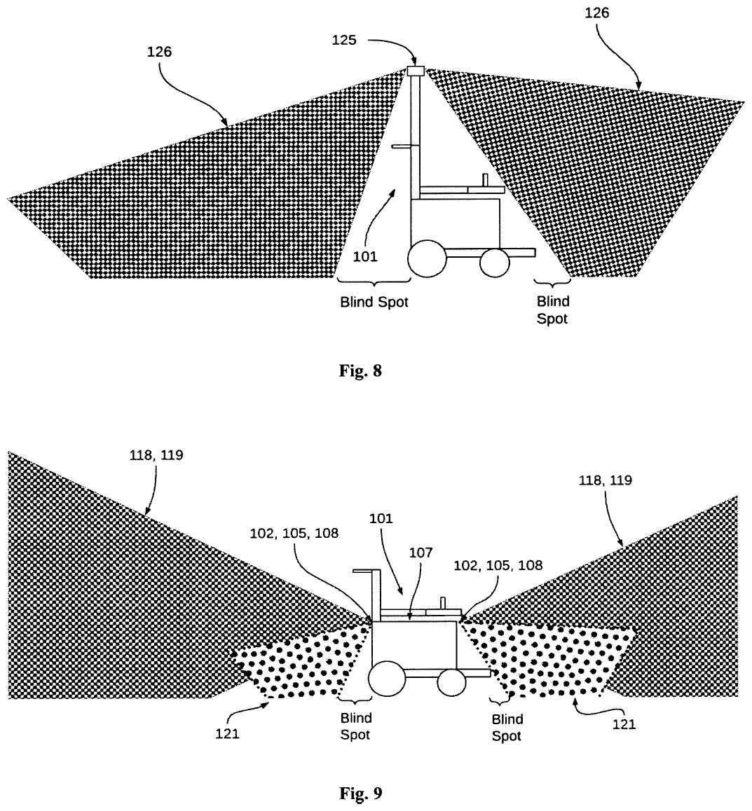

In one embodiment, as shown in FIG. 9, the long-range sensors, such as structured light sensors 102, and vision sensor 105, and short-range sensors, like ultrasonic sensor 108 are placed on the torso 107 of the vehicle 101. FIG. 9. also shows structured long-range field view 118 from the structured light sensors 102, the vision long-range field of view of the vision sensor 105, and the short-range field of view of the ultrasonic sensor 121. Also, the placement of the LIDAR system on the torso of the wheelchair and ultrasonic sensor, along with TOF or proximity sensors on the torso of the vehicle can be provided in such embodiment. The key thing to note is that there is a distinct possibility of the long-range and short-range systems to be occluded by the rider with the trade-off of a larger camera blind spot which is compensated for by the short-range sensors.

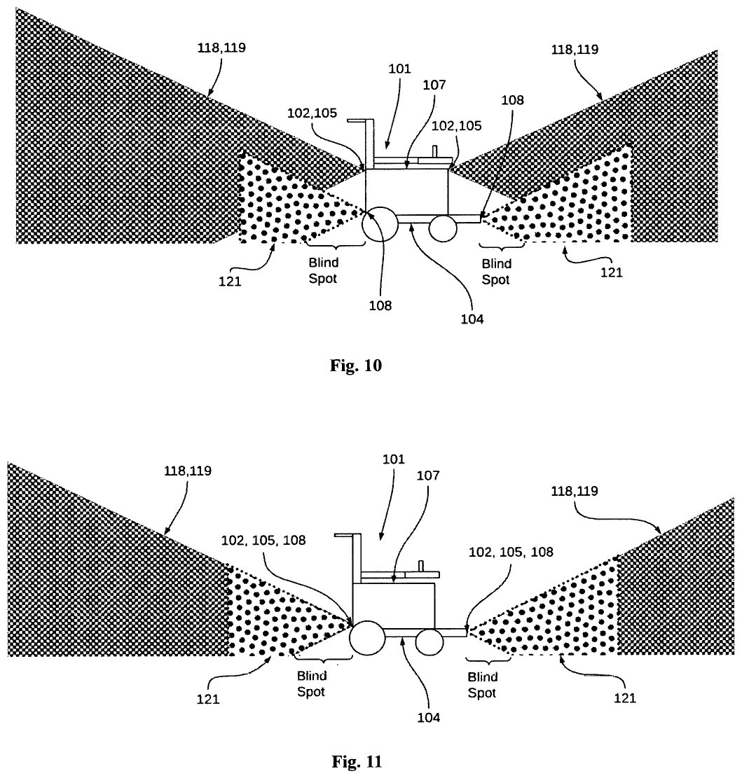

In another embodiment, long-range sensors such as structured light sensors 102, and vision sensor 105 are placed on the torso 107 of the vehicle 101, and short-range sensors, like ultrasonic sensor 108 can be placed on the skirts 104 of the vehicle 101, as shown in FIG. 10. FIG. 10. also shows the long-range field view 118 of the structured light sensors 102, the vision long-range field of view of the vision sensor 105, and the short-range field of view 121 of the ultrasonic sensor 108. Also, LIDAR systems can be placed on the torso of the wheelchair, and ultrasonic, TOF or proximity sensors can be placed along the skirt of the vehicle. The choice of the inclusion of a flagpole is optional. In this configuration, there is a distinct possibility of the camera or any other long-range sensor system to be occluded by the rider with the trade-off of a larger camera blind spot which is compensated for by the short-range sensors.

In yet another embodiment, both long-range sensors such as structured light sensors 102, and vision sensor 105, and short-range sensors, like ultrasonic sensor 108 can be placed on the skirt 104 of the vehicle 101, as shown in FIG. 11. FIG. 11. also shows structured long-range field view 118 from the structured light sensors 102, the vision long-range field of view 119 of the vision sensor 105, and the short-range field of view 121 of the ultrasonic sensor 108. Also, LIDAR systems, as well as, ultrasonic, TOF or proximity sensors, shall be placed on the skirt of the wheelchair; the choice of the inclusion of a flagpole is optional.

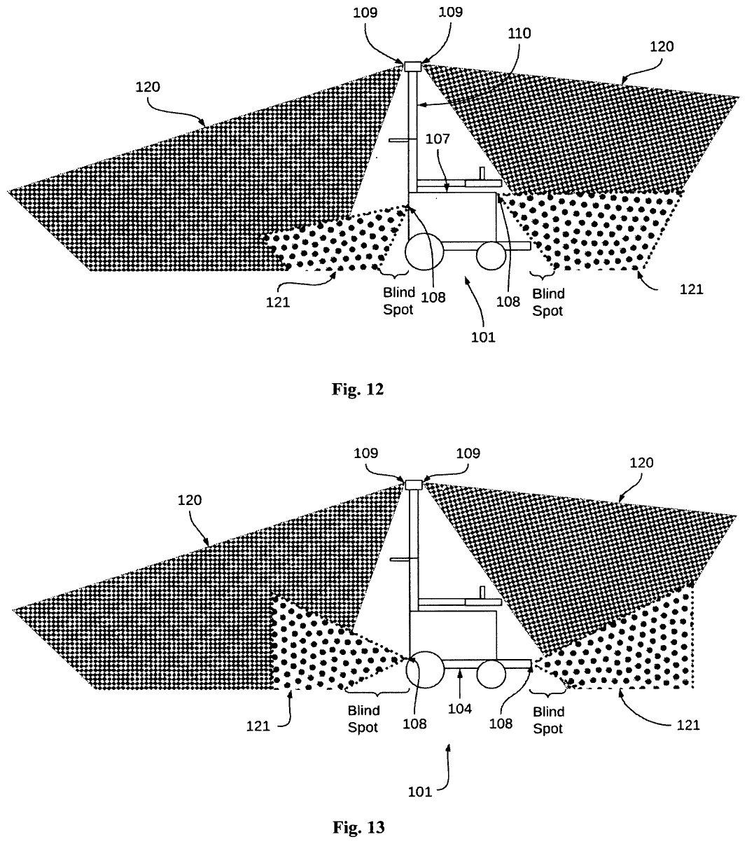

In yet another embodiment, the long-range sensors (herein names as elevated sensor 109) shall be placed on an elevated structure 110, while the short-range sensors, such as ultrasonic sensor 108 shall be placed on the torso 107 of the vehicle 101 or the wheelchair, as shown in FIG. 12. This FIG. 12. also shows the elevated long-range field of view 120 of the elevated sensor 109, and the short-range field of view 121 of the ultrasonic sensor 108. The key advantage here is a shorter blind spot, but the range of the short-range sensors is quite compromised to achieve this shorter blind spot. Also, the chance for the short-range sensors to get occluded and all the disadvantages of the high vantage point of the camera possibly being occluded by the passenger is a disadvantage.

In another embodiment of FIG. 12, the elevated sensor 109 is a long-range 360° camera along with short-range sensors on the torso is shown in FIG. 12. While the depth will be estimated here with the use of neural network solutions, the large blind spot area is compensated for with the narrow-range sensors.

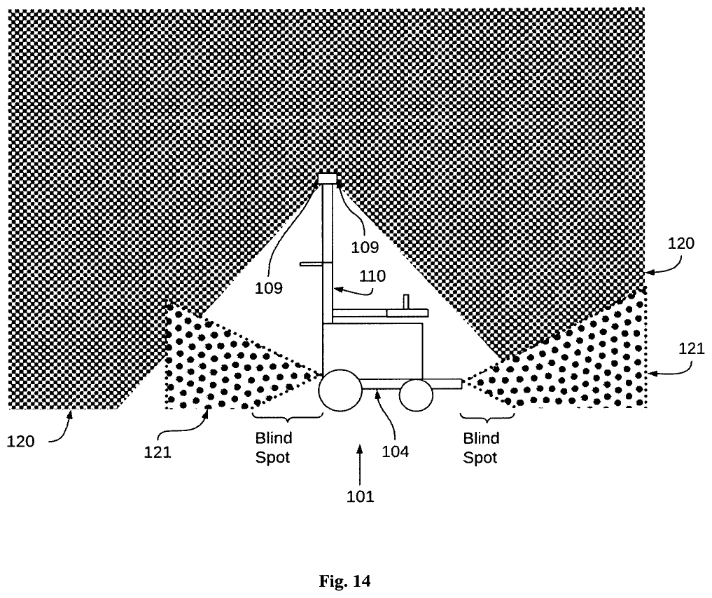

In yet another embodiment, the long-range elevated sensors 109 shall be placed on the flagpole 110, and the short-range sensors, like ultrasonic sensor 108 shall be placed on the skirt 104 of the vehicle or the wheelchair 101, as shown in FIG. 13. This FIG. 13. also shows an elevated long-range field of view 120 of the elevated sensor 109, and the short-range field of view 121 of the ultrasonic sensor 108. Also, vision sensors or LIDAR systems can be placed on the flagpole above the wheelchair and TOF or proximity sensors can be placed along the skirt of the vehicle. The key advantage here is a shorter blind spot as governed by the long-range sensors. The disadvantages of the high vantage point of the long-range sensors possibly being occluded by the passenger is a disadvantage.

In another embodiment, the elevated sensor 109, which is a long-range vision sensor like a 360° camera is placed on the flagpole 110 with short-range sensors, such as ultrasonic sensor 108 is placed on the skirt 104 of the vehicle 101 is shown in FIG. 14. This FIG. 14. also shows the elevated long-range field of view 120 of the elevated sensor 109, and the short-range field of view 121 of the ultrasonic sensor 108. While the depth will be estimated here with the use of neural network solutions, the large blind spot area is compensated for with the narrow-range sensors.

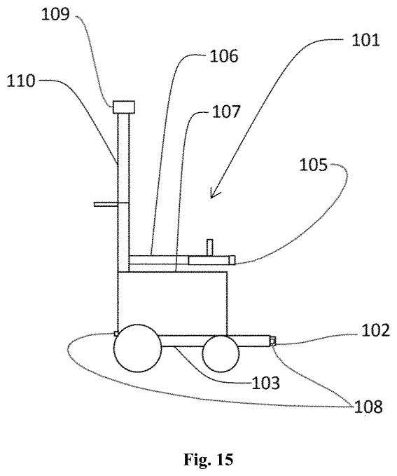

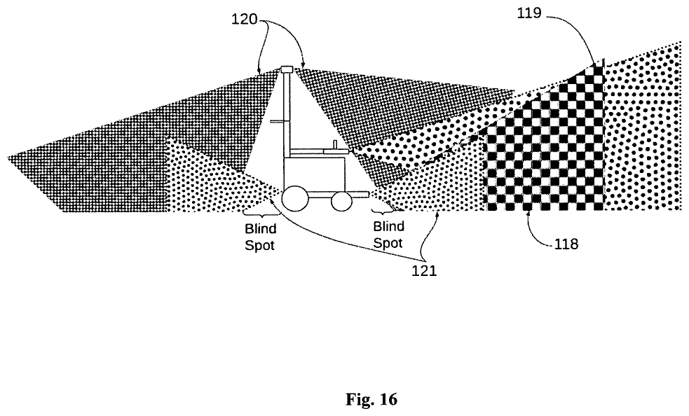

In one preferred embodiment, as shown in FIG. 15, there are four types of sensors 102, 105, 108, 109 which are placed onto the personal mobility vehicle 1. One of them is a structured light sensor 102 coupled to a base frame 103 onto which the wheels of the vehicle 101 are attached. In an alternate embodiment, the structured light sensor 102 can be coupled to the skirt of the vehicle 101. Another one is a vision sensor 105 coupled to the armrest 106 of the vehicle. In an alternate embodiment, the vision sensor 105 can also be coupled to the torso 107 of the vehicle 101. The third one is the ultrasonic sensor 108 coupled to the base frame 103 of the vehicle 101 are attached. In an alternate embodiment, the ultrasonic sensor 108 can be coupled to the skirt 104 of the vehicle 1. Fourth one is the elevated sensor 109 coupled to an elevated structure 110 of the vehicle 101 above the height of the head of a user of the vehicle 101 when the user is seated on the vehicle 101. In an alternate embodiment, the vision sensor 105, the ultrasonic sensor 108 and the elevated sensor 109 may not be present or may be located in a different position onto the vehicle 101.

FIG. 16 shows different fields of view 118, 119, 120, 121 of each of the sensors. An elevated sensor placed on an elevated structure has an elevated long-range field of view 120. A structured light sensor placed onto the base frame has a structured long-range field of view 118. The vision sensor located on the armrest has a vision long-range field of view 119. The ultrasonic sensor placed onto the base frame has a short-range field of view 121. The placement of sensors in such a way helps in covering the maximum possible area of the environment while providing optimal spatial resolution of the obstacles, keeping in mind limited computational resources usage.

Sensor placement on the vehicle is critical as it allows for the choice of sensors and desired field of view to be evaluated such that the best trade-off can be made. In FIG. 16, representative locations for the sensors are indicated based on their specific fields of view 118, 119, 120, 121 while also ensuring that the rider on the vehicle does not block the field of view. The short-range sensors are placed along the front, sides, and rear of the vehicle, specifically on the front extension and rear luggage assembly to ensure that obstacles in close range are always visible to the sensors. This is the case for the structured light sensor as well which are co-located on the same subassembly as the front ultrasonic sensors. Long-range sensors are placed by the armrest and also, if needed, on the flagpole to provide a wide field of view to the sensors while also ensuring that the rider on the vehicle does not obstruct the field of view. The short-range sensors can also be time of flight sensors, short-range radar sensors, or other proximity sensors. The long-range sensors can also be multi-camera systems that enable depth extraction and the ability to understand the scene.

In one embodiment, a sensor system can be provided which can be attached to any existing powered wheelchair or personal mobility vehicle. In such a scenario, various mechanical coupling arrangements can be provided to couple the sensors to various locations of the vehicle. A first mechanical coupling can be provided to couple the structured light sensor to the base frame, or a skirt of the vehicle. A second mechanical coupling is adapted to couple the vision sensor to an armrest of the vehicle or the torso of the vehicle. A third mechanical coupling can be provided to couple the ultrasonic sensor to the base frame of the vehicle, or a skirt of the vehicle. The fourth mechanical coupling can be provided to couple the elevated sensors to the elevated structure of the vehicle above the height of the head of a user of the vehicle when the user is seated on the vehicle. In one scenario, all the sensors may not be used, hence all the mechanical couplings may not be required. In another scenario, some of the sensors are already fixed to the relevant locations of the vehicle, and hence not all the sensors are not required to be placed externally, and accordingly, not all the mechanical couplings may be required. These sensors may be coupled to an existing computational processing unit of the vehicle, or a separate processing unit can be loaded to handle and process data from the sensors to determine the location of the obstacles.

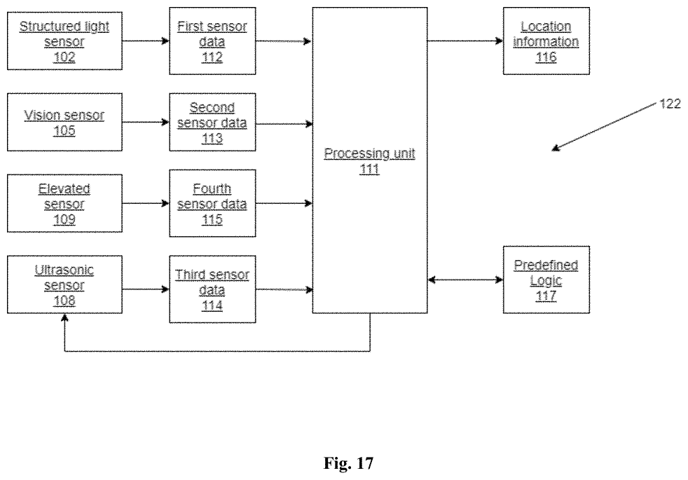

FIG. 17 shows a schematic diagram of a system 122 of sensors 102, 105, 108, 109 and processing unit 111 determining location information 116 of obstacles in the environment where the vehicle is placed. The system 122 includes one or more structured light sensor 102, one or more vision sensors 105, one or more ultrasonic sensors 108, and one or more elevated sensors 109. The structured light sensors 102 senses one or more obstacles and generates a first sensor data 112. The vision sensor 105 senses one or more obstacles and generates a second sensor data 113. The ultrasonic sensors 108 senses one or more obstacles and generates a third sensor data 114. The elevated sensors 109 senses a fourth sensor data 115 comprising either a depth information of the obstacles, or a raw location information of the obstacles, or both. The processing unit 111 receives and processes the first sensor data 112, the second sensor data 113, the third sensor data 114, and the fourth sensor data 115, and generates a location information 116 of one or more obstacles. In one embodiment, where all the sensors 102, 105, 108, 109 are not used, the processing unit 111 uses only some of the first sensor data 112, the second sensor data 113, the third sensor data 114, and the fourth sensor data 115 for processing and generating the location information 116 of the obstacles.

To optimize utilization of the computational resources, all the ultrasonic sensors 108 are not fired in one go, rather they are fired based on a predefined logic 117. The processing unit 111 activates the ultrasonic sensors 108 based on the predefined logic 17 where at least one of the ultrasonic sensors 108 is activated at a different time frame with respect to activation of other ultrasonic sensors 108. In one scenario, where the predefined logic 117 defines for activation of the ultrasonic sensors 108 which has a field of view in a direction of movement of the vehicle, the processing unit 111 activates the ultrasonic sensors 108 which has the field of view in the direction of the vehicle.

Of particular importance in this disclosure, is the combination of data from the long-range and short-range sensors so that there is complete coverage of the scene in the vicinity of the wheelchair.

Specifically, the inclusion of the long-range sensors on the flagpole, or torso, or the skirt of the vehicle gives the vehicle the ability to see objects and obstacles in varying degrees of distance: the flagpole being the longest range possible followed by the torso position, followed by the skirt position. However, each also comes with its shortcomings with possible occlusion by the rider or their clothing and different sizes of blind spots.

The inclusion of short-range sensors is specifically envisioned to be on the torso or the skirt of the vehicle for two reasons. Firstly, the sensors are better able to “see” the area that is not visible to the long-range sensors and ensure collision avoidance. Secondly, given the range of distances measurable by these short-range sensors, the importance of inclusion near the perimeter of the vehicle as opposed to the vantage points of the long-range sensors is critical.

The combination of these two different types of sensors in potentially two different locations is of significance, as it shall provide the diversity in the type of data available for collision avoidance, path planning, and wayfinding is of unique value.

### LIST OF REFERENCE SIGNS

00, 01, 02, 10, 11, 12, 20, 21, 22, 30, 31, 32. Field of view of short-range sensors
100. Short-range sensors
101. Personal mobility vehicle/Wheelchair
102. Structured light sensor
103. Base frame
104. The skirt of the vehicle
105. Vision sensor
106. Armrest
107. Torso of the vehicle
108. Ultrasonic sensors
109. Elevated sensors
110. Elevated structure
111. Processing unit
112. First sensor data
113. Second sensor data
114. Third sensor data
115. Fourth sensor data
116. Location information
117. Predefined logic
118. Structured long-range field of view
119. Vision long-range field of view
120. Elevated long-range field of view
121. Short-range field of view
122. System
123. Camera sensor
124. Camera FOV
125. Depth cameras
126. Depth camera FOV

1. A sensor system to be placed onto a personal mobility vehicle comprising:
a structured light sensor adapted to sense one or more obstacles and adapted to generate a first sensor data,
a first mechanical coupling adapted to couple the structured light sensor to:
a base frame onto which the wheels of the vehicle are attached, or
a skirt of the vehicle, and
a processing unit adapted to receive and process the first sensor data to determine a depth of one or more obstacles, and further generate a location information of one or more obstacles.

2. The sensor system according to claim 1, wherein the structured light sensor is adapted to sense the obstacles placed in a distance range of 50 centimeters to 800 centimeters.

3. The sensor system according to claim 1 comprising:
a vision sensor adapted to sense one or more obstacles and adapted to generate a second sensor data, and
a second mechanical coupling adapted to couple the vision sensor to:
an armrest of the vehicle, or
a torso of the vehicle,
wherein the processing unit adapted to receive and process the first sensor data and the second sensor data and to generate the location information of one or more obstacles.

4. The sensor system according to claim 3, wherein the vision sensor is adapted to sense the obstacles placed in a distance range of 50 centimeters to 800 centimeters.

5. The sensor system according to claim 1 comprising:
an ultrasonic sensor adapted to sense one or more obstacles and adapted to generate a third sensor data, and
a third mechanical coupling adapted to couple the ultrasonic sensor to:
a base frame onto which the wheels of the vehicle are attached, or
a skirt of the vehicle,
wherein the processing unit adapted to receive and process the first sensor data and the third sensor data and to generate the location information of one or more obstacles.

6. The sensor system according to claim 5, wherein the ultrasonic sensor is adapted to sense the obstacles placed in a distance range of 0 centimeters to 300 centimeters.

7. The sensor system according to claim 5 comprising more than one ultrasonic sensor, and the processing unit is adapted to activate the ultrasonic sensors based on a predefined logic where at least one of the ultrasonic sensors is activated at a different time frame with respect to activation of other ultrasonic sensors.

8. The sensor system according to claim 7, wherein the predefined logic defines for activation of the ultrasonic sensors which has a field of view in a direction of movement of the vehicle, and accordingly, the processing unit is adapted to activate the ultrasonic sensors that have the field of view in the direction of the vehicle.

9. The sensor system according to claim 1 comprising:
one or more elevated sensors include:
one or more depth sensors, or
one or more image sensors, or both,
and adapted to sense a fourth sensor data comprising either a depth information of the obstacles, or a location information of the obstacles, or both,
a fourth mechanical coupling to adapted to couple the elevated sensors to an elevated structure of the vehicle above the height of the head of a user of the vehicle when the user is seated on the vehicle,
wherein the processing unit adapted to receive and process the first sensor data and the fourth sensor data and to generate the location information of one or more obstacles.

10. The sensor system according to claim 9, wherein the elevated sensors are mechanically coupled to the elevated structure, such that the elevated sensors are vertically tilted downwards.

11. A personal mobility vehicle comprising:
a structured light sensor coupled to either:
a base frame onto which the wheels of the vehicle are attached, or
a skirt of the vehicle, and
adapted to sense one or more obstacles and adapted to generate a first sensor data,
a processing unit adapted to receive and process the first sensor data to determine a depth of one or more obstacles, and further generate a location information of one or more obstacles.

12. The personal mobility vehicle according to claim 11, wherein the structured light sensor is adapted to sense the obstacles placed in a distance range of 50 centimeters to 800 centimeters.

13. The personal mobility vehicle according to claim 11 comprising:
a vision sensor coupled to either:
an armrest of the vehicle, or
a torso of the vehicle, and
adapted to sense one or more obstacles and adapted to generate a second sensor data, wherein the processing unit adapted to receive and process the first sensor data and the second sensor data and to generate the location information of one or more obstacles.

14. The personal mobility vehicle according to claim 13, wherein the vision sensor is adapted to sense the obstacles placed in a distance range of 50 centimeters to 800 centimeters.

15. The personal mobility vehicle according to claim 11 comprising:
an ultrasonic sensor coupled to either:
a base frame onto which the wheels of the vehicle are attached, or
a skirt of the vehicle, and
adapted to sense one or more obstacles and adapted to generate a third sensor data, and wherein the processing unit adapted to receive and process the first sensor data and the third sensor data and to generate the location information of one or more obstacles.

16. The personal mobility vehicle according to claim 15, wherein the ultrasonic sensor is adapted to sense the obstacles placed in a distance range of 0 centimeters to 300 centimeters.

17. The personal mobility vehicle according to claim 15 comprising more than one ultrasonic sensor, and the processing unit is adapted to activate the ultrasonic sensors based on a predefined logic where at least one of the ultrasonic sensors is activated at a different time frame with respect to activation of other ultrasonic sensors.

18. The personal mobility vehicle according to claim 17, wherein the predefined logic defines for activation of the ultrasonic sensors which has a field of view in a direction of movement of the vehicle, and accordingly, the processing unit is adapted to activate the ultrasonic sensors that have the field of view in the direction of the vehicle.

19. The personal mobility vehicle according to claim 11 comprising:
one or more elevated sensors include:
one or more depth sensors, or
one or more image sensors, or both,
and coupled to an elevated structure of the vehicle above the height of the head of a user of the vehicle when the user is seated on the vehicle and adapted to sense a fourth sensor data comprising either a depth information of the obstacles, or a location information of the obstacles, or both,
wherein the processing unit adapted to receive and process the first sensor data and the fourth sensor data and to generate the location information of one or more obstacles.

20. The personal mobility vehicle according to claim 19, wherein the elevated sensors are mechanically coupled to the elevated structure, such that the elevated sensors are vertically tilted downwards.
